(19) United States
(12) Patent Application Publication
(10) Pub. No.: US 2015/0205834 A1
(43) Pub. Date: Jul. 23, 2015

(54) PROVIDING FILE METADATA QUERIES FOR FILE SYSTEMS USING RESTful APIs

(71) Applicant: HEWLETT-PACKARD DEVELOPMENT COMPANY, L.P., Fort Collins, CO (US)

(72) Inventors: Kimberly Keeton, San Francisco, CA (US); Evandro Sombrio, Porto Alegre (BR); Leandro Morais Nunes, Porto Alegre (BR); Alistair Veitch, Mountain View, CA (US)

(73) Assignee: HEWLETT-PACKARD DEVELOPMENT COMPANY, L.P., Fort Collins, CO (US)

(21) Appl. No.: 14/160,030

(22) Filed: Jan. 21, 2014

(51) Int. Cl. G06F 17/30

(52) U.S. Cl. CPC G06F 17/30392; G06F 17/30466

(57) ABSTRACT

Example embodiments relate to providing file metadata queries for file systems using representational state transfer compliant (RESTful) application programming interfaces. In example embodiments, a representational state transfer (REST) request that includes requested attributes and search parameters is received. Then, a metadata source including source attributes that correspond to the requested attributes is identified using the translation configuration. The translation configuration of the metadata source is also used to convert the search parameters to obtain converted parameters that are compatible with the metadata source. At this stage, a metadata query for the metadata source that includes the requested attributes and the converted parameters is created.

### BACKGROUND

Unstructured data such as files are typically stored in modern Information Technologies (IT) systems. This practice often involves information management and compliance issues. For example, system administrators may want to quickly and efficiently find files that match a given criteria, applications may wish to “tag” files with custom metadata and query that metadata, utilities may want to efficiently determine which files have changed and are in need of backup, and legal staff may want to find files that meet e-discovery criteria. Various implementations of these IT systems use a standard database to augment metadata provided by file systems to achieve these goals.

### BRIEF DESCRIPTION OF THE DRAWINGS

The following detailed description references the drawings, wherein:

FIG. 1 is a block diagram of an example computing device for providing file system metadata queries for representational state transfer compliant (RESTful) application programming interfaces (APIs);

FIG. 2 is a block diagram of an example server computing device including modules for providing file system metadata queries for RESTful APIs;

FIG. 3 is a flowchart of an example method for execution by a computing device for providing file system metadata queries for RESTful APIs; and

FIG. 4 is a flowchart of an example method for execution by a computing device for processing file data source updates and providing file system metadata queries for RESTful APIs.

### DETAILED DESCRIPTION

As detailed above, an IT system may use a standard database to augment metadata provided by a file system (i.e., file data source) to allow users to effectively search for files within the file system. Such an IT system is not typically in-line with the file system, which significantly restricts its functionality and does not provide a single interface for searching both system metadata and custom metadata. Custom metadata is metadata defined by the user to allow for additional characteristics to be associated with files in the file system. In some cases, custom metadata may be stored in a standard database. Alternatively, custom metadata may be stored in the the system as an extended attribute. In this scenario, the extended attribute approach results in decreased search performance because a the system scan is used. System metadata is other metadata maintained by the file system (e.g., the size and owner in standard the systems and potentially other attributes like retention state in more specialized file systems). Further, several file system search tools can be used to search the properties such as size. However, these tools update their indices by scanning the file system, an operation that incurs inefficient random disk accesses. Such scans can take considerable time (e.g., days) for a large the system and will become successively slower as the size of the file system grows. Further, the search results provided by these tools become outdated quickly because of the considerable time it takes to scan a file system. When coupled, the tools are restricted to file systems on a single machine. Finally, these tools are often not accessible via a RESTful API.

Example embodiments disclosed herein provide file metadata queries using RESTful APIs. For example, in some embodiments, a representational state transfer (REST) request that includes requested attributes and search parameters is received. The search parameters may include query conditions for restricting output that is provided in response to the REST request. Then, a metadata source including source attributes that correspond to the requested attributes is identified using the translation configuration. The metadata source may store system metadata and/or custom metadata as described below, where the translation configuration describes a data schema of the metadata source. The translation configuration of the metadata source is also used to convert the search parameters to obtain converted parameters that are compatible with the metadata source. At this stage, a metadata query for the metadata source that includes the source attributes and the converted parameters is created. RESTful APIs may also be used to store and update the custom metadata attributes in the metadata source.

In this manner, example embodiments disclosed herein provide file metadata search capabilities using RESTful APIs by processing RESTful requests as metadata source queries. Specifically, a RESTful request is used to generate a metadata query based on attributes of the file data source, associated metadata tables, and user-provided search parameters. Further, because RESTful APIs allow for custom metadata to be stored, a translation configuration may be used to efficiently access the custom metadata when fulfilling the RESTful request.

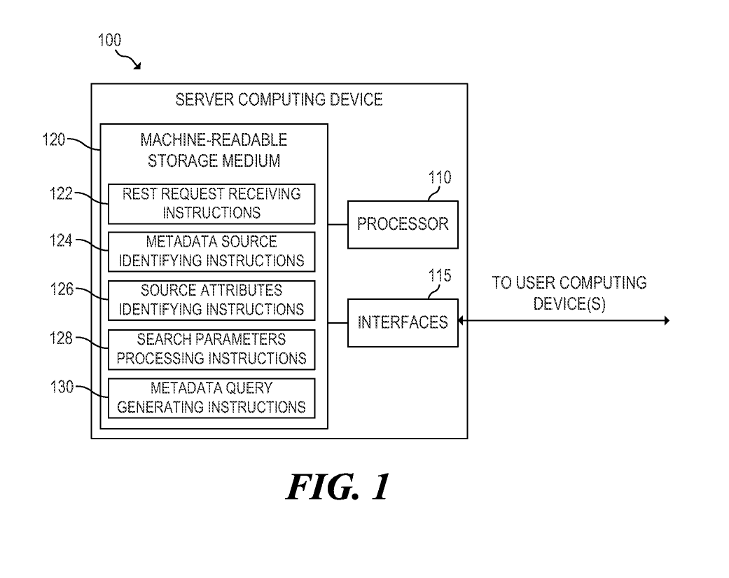

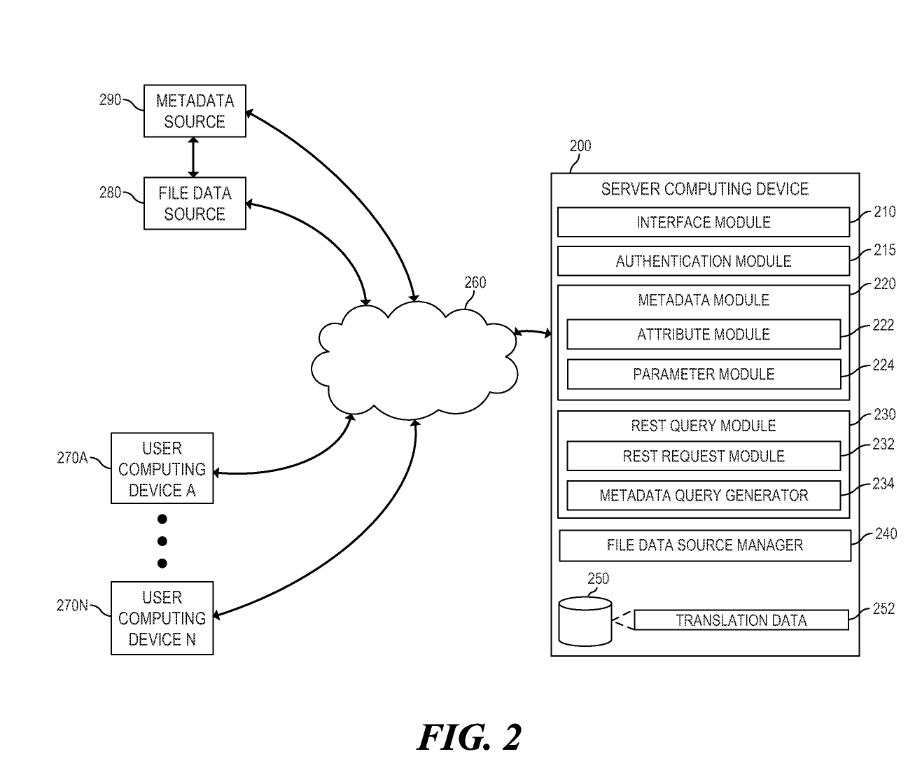

Referring now to the drawings, FIG. 1 is a block diagram of an example server computing device 100 for providing file system metadata queries for RESTful APIs. Server computing device 100 may be any computing device (e.g., database server, file server, desktop computer, etc.) that is accessible by user computing devices, such as user computing device A 270A and user computing device N 270N of FIG. 2. In some cases, server computing device 100 may be configured as a distributed system including multiple servers. In the embodiment of FIG. 1, server computing device 100 includes a processor 110, an interface 115, and a machine-readable storage medium 120.

Processor 110 may be one or more central processing units (CPUs), microprocessors, and/or other hardware devices suitable for retrieval and execution of instructions stored in a non-transitory, machine-readable storage medium 120. Processor 110 may fetch, decode, and execute instructions 122, 124, 126, 128, 130 to provide file system metadata queries for RESTful APIs, as described below. As an alternative or in addition to retrieving and executing instructions, processor 110 may include one or more electronic circuits comprising a number of electronic components for performing the functionality of one or more of instructions 122, 124, 126, 128, 130.

Interfaces 115 may include a number of electronic components for communicating with data sources (e.g., metadata source 290, file data source 280) and user computing devices (e.g., user computing device A 270A, user computing device N 250). For example, interfaces 115 may include a Serial Advanced Technology Attachment (SATA) interface, Ethernet interface, or any other physical connection interface suitable for communication with the data sources and the user computing device(s). Alternatively, interfaces 115 may be a wireless interface, such as a wireless local area network (WLAN) interface or a near-field communication (NFC) interface. In operation, as detailed below, interfaces 115 may be used to send and receive data to and from a corresponding interface of a data source or a user computing device.

Machine-readable storage medium 120 may be any non-transitory electronic, magnetic, optical, or other physical storage device that stores executable instructions. Thus, machine-readable storage medium 120 may be, for example, Random Access Memory (RAM), non-volatile RAM, an Electrically-Erasable Programmable Read-Only Memory (EEPROM), a storage drive (e.g., hard disk drive, solid state drive, flash drive, etc.), an optical disc, and the like. As described in detail below, machine-readable storage medium 120 may be encoded with executable instructions for providing file system metadata queries for RESTful APIs.

REST request receiving instructions 122 processes REST requests that are received from user computing devices. For example, a REST GET request may be processed to identify the parameters of the request. In this example, the inputs of the GET request may include requested attributes and search parameters. Further, additional directives such as output presentation (e.g., sort order, output format, paging, etc.) may be included in the GET request. Requested attributes may refer to metadata fields associated with data objects (e.g., files) managed by a metadata source. Examples of requested attributes include file name, file owner, last modified date, user-defined custom metadata tags, etc. Search parameters may refer to query conditions for restricting output that is provided in response to the GET request. Further, search parameters may specify values for the data fields of the data objects (e.g., file_name=′Filename.txt′, lastModifiedTime>3-28-2012, or regular expression matches such as my_custom_tag_name˜foo.*, etc.). REST request receiving instructions 122 may process a REST request by parsing the request to identify the requested attributes and search parameters and then converting the attributes and parameters as described below.

Representational state transfer (REST) is a remote procedure call architectural style that simplifies calls between devices over the Internet, REST is typically used as an alternative to complex protocols such as simple object access protocol (SOAP), web service definition language (WSDL), etc. REST is preferred to these complex protocols because it allows parameters to be passed directly in a web address (i.e., uniform resource locator (URL)) instead of requiring burdensome extensible markup language (XML) or similar techniques for passing parameters. REST responses to requests are often in the form of XML files; however, REST is not restricted to any particular format. Other formats such as comma-separated values (CSV) or JavaScript Object Notation (JSON) can also be used to provide REST responses.

Metadata source identifying instructions 124 identify a metadata source based on the processed REST request. The metadata source may store metadata for content that is stored in, for example, a distributed file system. The metadata source may provide metadata for a uniform resource identifier (URI) that defines the scope of the REST request (e.g., a particular directory or file). For example, the metadata source may be specified as a parameter in the URL of the REST request. In another example, each URL for REST services provided by server computing device 100 may be associated with a particular metadata source. Further, the metadata source may be associated with a translation configuration that describes metadata tables that store the metadata describing the content of the file data source. The identified metadata source and associated metadata tables can then be used as described below to generate a metadata query (e.g., a structured query language (SQL) query).

Source attributes identifying instructions 126 may identify source attributes in the metadata source that correspond to the requested attributes referred to in the REST request. Specifically, the translation configuration may include data mappings that are used to identify each source attribute from its corresponding requested attribute, where the translation configuration describes the data schema of the metadata source and the location of the source attributes. In some cases, if the metadata source is a database, the requested attributes may be translated into database table columns, which are used in a metadata query described below. For example, the metadata source may include the database table FileObjects with columns fileSize, lastModifiedTime, fileOwner and the database table CustomAttributes with columns attributeKey and attributeValue. In this example, the REST-visible attributes may include system::size, system::lastModifiedTime and system::owner, and the custom attributes may be provided according to their user-defined name (e.g., color or shape), with string values (e.g., ‘red’ or ‘circle’). In other cases, the REST request may not include source attributes if the REST request is requesting, for example, a delete, alter, or insert operation for performing modifications on the metadata source. In these other examples, the REST request may instead specify target attributes to be altered or inserted.

Parameter processing instructions 128 may identify constraints on the parameters extracted from the REST request for a metadata search. Each search parameter may constrain the requested value for a source attribute of the metadata source. In this case, the search parameter may be mapped to a source attribute in the metadata source based on the translation configuration. For example, a REST request may include a constraint (e.g., system::filename=‘file_name’) that specifies a value for system::filename that is equal to a source parameter ‘data_column_file_name’ in a metadata source. In this example, each of the search constraints may be converted to predicates for a data entity (e.g., database table) in the metadata source.

Metadata query generating instructions 130 may generate a metadata query for the metadata source based on the requested attributes and the converted search parameters. For example, a SQL SELECT statement may be generated for obtaining the requested attributes from the metadata source with a SQL WHERE clause that includes predicates for the search parameters. In this example, the requested attributes may be associated with files stored in the file data source, where the select statement returns data records from the metadata tables in response to the REST request.

FIG. 2 is a block diagram of an example server computing device 200 in communication via a network 260 with user computing devices (e.g., user computing device A 270A, user computing device N 270N), file data source 280, and metadata source 290. As illustrated in FIG. 2 and described below, server computing device 200 may communicate with user computing devices (e.g., user computing device A 270A, user computing device N 270N) to provide file system metadata queries for RESTful APIs.

As illustrated, server computing device 200 may include a number of modules 210-240. Each of the modules may include a series of instructions encoded on a machine-readable storage medium and executable by a processor of the server computing device 200. In addition or as an alternative, each module may include one or more hardware devices including electronic circuitry for implementing the functionality described below.

As with server computing device 100 of FIG. 1, server computing device 200 may be a database server, file server, desktop computer, or any other device suitable for executing the functionality described below. As detailed below, server computing device 200 may include a series of modules 210-240 for providing file system metadata queries for RESTful APIs.

Interface module 210 may manage communications with the user computing devices (e.g., user computing device A 270A, user computing device N 270N). Specifically, the interface module 210 may (1) receive requests from user computing devices (e.g., user computing device A 270A, user computing device N 270N) via RESTful APIs. Interface module 210 may also process authorization of user computing devices (e.g., user computing device A 270A, user computing device N 270N) to access metadata source 290. Specifically, interface module 210 may receive credentials from user computing devices (e.g., user computing device A 270A, user computing device N 270N) and request that authentication module 215 determine whether user computing devices (e.g., user computing device A 270A, user computing device N 270N) are authorized to access the metadata in metadata source 290. If user computing devices (e.g., user computing device A 270A, user computing device N 270N) are properly authorized, interface module 215 may then allow user computing devices (e.g., user computing device A 270A, user computing device N 270N) to communicate with the other modules of server computing device 200.

Metadata module 220 may facilitate interactions with metadata source 290. Specifically, metadata module 220 may obtain metadata table information from the metadata source 290. For example, metadata module 220 may use the data schema of the metadata source to identify a metadata table that contains particular attribute(s). Metadata module 220 may also be configured to initiate metadata commands on metadata source 290 such as query, insert, update, and delete commands to modify the metadata. In some cases, file data source 280 may correspond to a distributed file system, and metadata source 290 may correspond to a metadata database.

Attribute module 222 may retrieve requested attributes from metadata source 290 as directed by REST query module 230 to satisfy REST requests that are processed by request query module 230 as described below. To obtain the requested attributes, attribute module 222 may consult translation configurations (e.g., lookup tables) to determine the location of the requested attributes in the metadata source 290, where the translation configurations are stored as translation data 252 in storage device 250. For example, attribute module 222 may consult a lookup table to identify fields in metadata tables that correspond to the requested attributes of the files. A translation configuration maps requested attributes (i.e., REST API-visible attribute names such as system::path) to the correct metadata table and attribute (e.g. database column(s) such as the pathname column in a the objects table).

Attributes may include system attributes, which are native attributes of the file data source 280, and custom attributes, which are user-configured attributes that are associated with the files and stored in metadata source 290. In some cases, the system attributes may be mirrored in metadata source 290 to provide easier access to the attributes.

Parameter module 224 may process parameters associated with attributes of the files that are stored in the metadata source 290. Parameters may refer to conditions for the attributes that can be used to filter data results from associated metadata in metadata source 290. For example, a parameter may specify that an attribute should have a particular value as specified by a user of user computing devices (e.g., user computing device A 270A, user computing device N 270N). Parameter module 224 may be configured to verify that the values specified for an attribute are valid. In this example, an attribute may be associated with a range of allowable values (e.g., alphanumeric characters, numeric long values, binary long objects, etc.) that parameter module 224 may use to verify the provided values in the parameters.

REST query module 230 may manage query creation for the metadata source 290. Although the components of REST query module 230 are described in detail below, additional details regarding an example implementation of module 230 are provided above in connection with instructions 122, 128, and 130 of FIG. 1.

In some cases, the flow for processing a REST request includes 1) parsing the REST request and 2) initiating an action (e.g., REST GET operation, REST PUT operation, etc.) that depends on the type of request. GET operations that include a metadata request are sent to the REST query module 230 so that a metadata query is constructed from the parameters in the GET operations. After the metadata query is constructed, REST query module 230 may send the query to the metadata source 290, where the query is processed as, for example, a database query with results returned to the REST query module 230. REST query module 230 then post-processes the results to convert their format into the appropriate output format (e.g., JSON) and, in some cases, to perform pagination operations (e.g., skipping over the first N results, suppressing the final M results, etc.).

REST request module 232 may process REST requests received from the user computing devices (e.g., user computing device A 270A, user computing device N 270N). Specifically, REST request module 232 may parse a URL in the REST request to identify a metadata source, attributes, and search parameters. For example, the URL may be associated with the metadata source and include URL parameters that specify the attributes and search parameters. REST request module 232 may also use metadata module 220 to identify metadata tables in the metadata source that are relevant to a REST request.

As discussed above, source attributes may include system and custom attributes. Custom attributes allow the user to define meaningful “tags” for files and directories in a file data source to allow for more intuitive search capabilities. In some cases (e.g., when metadata source 290 is implemented as a database), each custom attribute is stored in its own row instead of allocating a single dynamically-sized metadata row per file or directory. In these cases, when a request selects one custom attribute and specifies a search parameter for another custom attribute, the custom attribute table is accessed multiple times: a first time to look for paths matching the criteria and a second time to retrieve the selected attributes, which results in SQL queries that contain nested SELECT statements.

Metadata query generator 234 may generate metadata queries for REST requests received from user computing devices (e.g., user computing device A 270A, user computing device N 270N). Specifically, a metadata query may be generated based on the identified metadata source, associated metadata tables, attributes, and search parameters. Metadata query generator 234 also uses metadata module 220 to generate the metadata query (i.e., a SQL query). For example, the metadata module 220 may be used to access the data schema of the metadata tables to determine how to efficiently join the metadata tables. In this example, the join of the metadata tables may be optimized based on the cardinality of relationships between the metadata tables. The variability of table cardinalities may result in metadata queries that use outer joins rather than traditional inner joins to preserve the values in the outer table when there are no matching rows in the inner table. Further, whereas the ordering of inner joins does not matter, the ordering of outer joins is important to preserve the non-matching rows. The metadata query generator 234 may be configured to correctly choose the appropriate type of join and, for outer joins, the correct order of tables to produce the desired set of results.

In another example optimization, more efficient directory lookups can be performed by partitioning the search on the pathname for a directory name and the search of the directory's contents for the directory name. Because the query is partitioned, indexes can be used to perform the query. In this example, the query may be partitioned into two SELECT statements, which are combined using the SQL UNION ALL operator. The first part of the UNION ALL query is for the “pathname=‘directory’” and the second part of the UNION ALL query is for “pathname LIKE ‘directory/%’” (if recursive) or “pathname LIKE ‘directory/%’ AND pathname NOT LIKE ‘directory/%/%’” (if non recursive).

In yet another optimization example, the SQL query created is configured to account for partially completed event processing in the metadata source. Specifically, in a metadata database for a distributed file system, events may be processed by the database in a different order than they were generated in the file system. This event processing coupled with asynchronous processing used to improve database ingest performance may result in file deletions that don't automatically delete custom attributes. As a result, the integrity of custom attributes should be explicitly enforced. Custom attributes for an old version of a file should no longer be visible to user requests once the file has been deleted, even if a new file has been created with the same pathname. To address these issues, the database may explicitly track file creation and deletion times as well as timestamps for custom metadata operations and may explicitly include logic in the generated SQL queries to check for attribute validity at query time. The metadata query generator 234 may be configured to automatically include the appropriate join between a custom attribute table and a file lifetime table to enforce the integrity of custom attributes.

Metadata query generator 234 assembles the different portions of the metadata query (e.g., the selected attributes, the requested attributes, how to encode the file/directory scope for the REST request, and any additional directives such as ordering) as described above. In some cases, these various modules may be implemented as a single component that performs the functionality described above to generate the metadata query.

In some cases, REST query module 230 runs as a part of an HTTP Server (httpd) module that processes REST requests for a hypertext transfer protocol (HTTP) service of file data source 280. File data source 280 may be a distributed file system that contains two or more nodes and provides a single global file namespace for storing data for user computing devices (e.g., user computing device A 270A, user computing device N 270N). A global namespace may be a heterogeneous, enterprise-wide abstraction of, for example, file information that is open to dynamic customization based on user-defined attributes as described above. In this case, there may be one logical metadata database (e.g., metadata source 290) for the distributed file system (e.g., file data source 280). Each node of the distributed file system may run a separate httpd that receives requests from the user computing devices (e.g., user computing device A 270A, user computing device N 270N) and initiates requests of the metadata source 290. Further, file content GET/PUT requests received by the httpd are sent through a separate path to the file data source 280.

Other types of REST requests include PUT requests to add/modify custom attributes or to set certain parameters (e.g., to change a file's state to immutable) in file data source 280. These PUT operations generate operations in file data source 280, which generate events through the normal file data source update mechanism. The events are then ingested into the underlying metadata source 290 to update its tables.

File data source module 240 may facilitate interactions with file data source 280. File data source module 240 may also provide user computing devices (e.g., user computing device A 270A, user computing device N 270N) with access to files stored in the file data source 280. The file data source typically stores files in directories, which group files based on a stored pathname. In other examples, alternative methodologies such as used-defined tags may be used to categorize the files. In some cases, the monitored data may be processed in a pipeline to conserve processor resources on metadata source 290. The pipeline may be associated with an update threshold such that the monitored data is queued until the update threshold is achieved, at which point the monitored data is processed to update the corresponding metadata.

Storage device 250 may be any hardware storage device for maintaining data accessible to server computing device 200. For example, storage device 250 may include one or more hard disk drives, solid state drives, tape drives, and/or any other storage devices. The storage devices may be located in server computing device 200 and/or in another device in communication with server computing device 200. As detailed above, storage device 250 may maintain translation data 252.

Server computing device 200 may provide various services) accessible to user computing devices (e.g., user computing device A 270A, user computing device N 270N) over the network 260 that is suitable for providing metadata that is related to content. File data source 280 may provide users with access to content such as files, and metadata source 290 may provide users with access to metadata of the content.

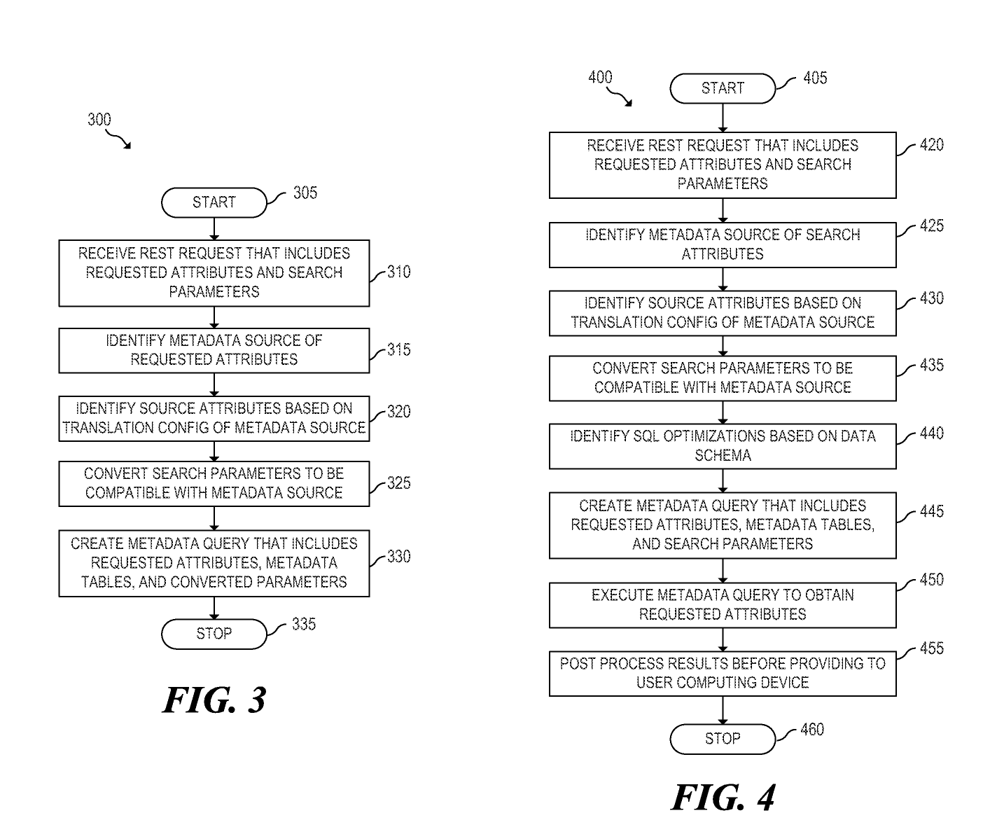

FIG. 3 is a flowchart of an example method 300 for execution by a computing device 100 for providing file system metadata queries for RESTful APIs. Although execution of method 300 is described below with reference to server computing device 100 of FIG. 1, other suitable devices for execution of method 300 may be used, such as server computing device 200 of FIG. 2. Method 300 may be implemented in the form of executable instructions stored on a machine-readable storage medium, such as storage medium 120, and/or in the form of electronic circuitry.

Method 300 may start in block 305 and continue to block 310, where server computing device 100 receives a REST request that includes requested attributes and search parameters. The REST request may be received as a URL for requested data such as metadata related to files satisfying the search parameters. In block 315, the metadata source of the requested attributes is identified. For example, the metadata source may be associated with a single file data source that includes the files so that the REST request is routed to the metadata source. In another example, the metadata source may be associated with the URL in a REST services look-up table (i.e., each URL providing a REST service may be associated with a particular metadata source).

In block 320, source attributes are identified based on the translation configuration of the metadata source. Specifically, search attributes specified in the search parameters may be identified in metadata tables of the metadata source. In block 325, the search parameters are converted to be compatible with the metadata source. For example, the source attributes identified in block 320 may be restricted with predicates as specified in the search parameters.

In block 330, a metadata query that includes the requested attributes, the metadata tables, and the converted search parameters is generated. Specifically, the metadata query may be configured to retrieve the requested attributes from the metadata tables as restricted by the converted parameters (e.g., predicates). Method 300 may then continue to block 335, where method 300 may stop.

FIG. 4 is a flowchart of an example method 400 for execution by a server computing device 200 for processing file data source updates and providing file system metadata queries for RESTful APIs. Although execution of method 400 is described below with reference to server computing device 200 of FIG. 1, other suitable devices for execution of method 400 may be used, such as server computing device 100 of FIG. 2. Method 400 may be implemented in the form of executable instructions stored on a machine-readable storage medium, such as storage medium 120 and/or in the form of electronic circuitry.

Method 400 may start in block 405 and continue to block 420, where server computing device 200 receives a REST request that includes requested attributes and search parameters. The REST request may be parsed to determine the type of action that should be initiated in response to the request. In this example, the REST request corresponds to a REST GET operation. The REST request may be in the form of a URL as shown in the following examples:

### Example 1

List the sizes for all files in directory ‘LiveDir’ with size>10240

REST URL—http://www.example.com/fileapi/LivDir/?attributes=system::size&query=system::size>10 240

### Example 2

Select all custom attributes for the ‘LiveDir/live1.txt’ REST URL—http://10.10.16.203/fileapi/LiveDir/live1.txt?attributes=custom::*

Where the examples' URLs include an address followed requested attributes (e.g., “attributes=system::size”, “attributes=custom::*”) and search parameters (e.g., “system::size>10240”). In this case, “system::size” is a system attribute that describes the size of a file in the file data source, and “custom::*” signifies that all custom attributes in the metadata source should be retrieved.

In block 425, the metadata source of the requested attributes is identified. In block 430, source attributes are identified based on a translation configuration of the metadata source. In block 435, the search parameters are converted to be compatible with the metadata source. In block 440, optimizations are identified based on the metadata schema. The metadata schema of the metadata source may describe how the source attributes are arranged in metadata tables of the metadata source. The data schema can be used to, for example, to optimize joins of metadata tables based on the cardinality of relationships between the metadata tables.

In block 445, a metadata query that includes the requested attributes, the metadata tables, the optimizations, and the converted parameters is generated. Specifically, the metadata query may be configured to retrieve the requested attributes from the metadata tables as restricted by the converted parameters (e.g., predicates). SQL queries generated from the REST URL's above are shown in the examples below:

### Example 1

List the sizes for all files in directory ‘LiveDir’ with size>10240

SQL Query:
SELECT fo.pathname, fo.fileSize AS “system::size” FROM
FileObjects_by_fileSize fo
WHERE fo.pathname = ‘LiveDir’ AND fo.fileSize > 10240
UNION ALL
SELECT fo.pathname, fo.fileSize AS “system::size” FROM
FileObjects_by_fileSize fo
WHERE (fo.pathname LIKE ‘LiveDir/%’ AND fo.pathname NOT LIKE
‘LiveDir/%/%’)
AND fo.fileSize > 10240;

### Example 2

Select all custom attributes for file ‘LiveDir/live1.txt’

SQL Query:
SELECT
selectedAttr.pathname,
attributekey,
attributevalue
FROM
(SELECT
akv.pathname AS pathname,
akv.poidHi64,
akv.poidLo32,
akv.attributekey,
akv.attributevalue
FROM AttributeKeyValue_by_pathname akv
LEFT OUTER JOIN InfluxFileLifetime_primary iffl
ON (akv.poidHi64 = iffl.poidHi64 AND akv.poidLo32 = iffl.poidLo32)
WHERE ((iffl.createTimeSec IS NULL AND iffl.createTimeNSec IS
NULL AND iffl.deleteTimeSec IS NULL AND iffl.deleteTimeNSec IS
NULL) OR ((akv.timestampSec > iffl.deleteTimeSec OR (
akv.timestampSec = iffl.deleteTimeSec AND akv.timestampNSec >=
iffl.deleteTimeNSec)) AND (akv.timestampSec > iffl.createTimeSec OR
(akv.timestampSec = iffl.createTimeSec AND akv.timestampNSec >=
iffl.createTimeNSec))))
AND akv.pathname = ‘LiveDir/live1.txt’
GROUP BY akv.pathname, akv.attributekey, akv.attributevalue,
akv.poidHi64, akv.poidLo32) AS selectedAttr
ORDER BY pathname;

Where the requested attributes from the URL are now converted to source attributes (e.g., fo.pathname, fo.fileSize AS “system::size”) that are being selected from a metadata table (e.g., FileObjects_by_fileSize fo) and restricted by search parameters in the form of predicates (e.g., fo.pathname=‘LiveDir’ AND fo.fileSize>10240). In Example 1, “fo” is a the objects data object in a file data source that is queried for the system attribute “fo.fileSize,” which is aliased as “system::size” for providing in response to the REST request. In Example 2, custom attribute keys (i.e., name) and values are from metadata tables of the metadata source that allow for any number of custom attributes to be associated with directories or files in the file data source.

In block 450, the metadata query is executed to obtain the requested attributes from the metadata tables. In block 455, the requested attributes may then be post-processed and provided to the user computing device in response to the REST request. Post processing may include, but is not limited to, converting particular attributes to the proper output format, pagination, etc. Method 400 may then continue to block 460, where method 400 may stop.

The foregoing disclosure describes a number of example embodiments for providing the system metadata queries for RESTful APIs. In this manner, the embodiments disclosed herein use a RESTful API to provide metadata by converting REST requests to metadata queries that are used to retrieve requested attributes from associated metadata tables.

We claim:

1. A system for providing the metadata queries for a file system using representational state transfer compliant (RESTful) application programming interfaces, the system comprising:
a processor to execute instructions that when executed by the processor direct the processor to:
receive a representational state transfer (REST) request that comprises a plurality of requested attributes and a plurality of search parameters;
identify a metadata source comprising a plurality of source attributes that corresponds to the plurality of requested attributes:
use a translation configuration of the metadata source to convert the plurality of search parameters to obtain a plurality of converted parameters that is compatible with the metadata source; and
create a metadata query for the metadata source that comprises the plurality of requested attributes and the plurality of converted parameters.

2. The system of claim 1, wherein the processor to execute instructions that when executed by the processor direct the processor further to:
execute the metadata query to obtain metadata that includes the plurality of requested attributes from the metadata source, wherein the plurality of requested attributes is associated with a plurality of files stored in the file data source.

3. The system of claim 1, wherein the plurality of source attributes comprises system attributes and custom attributes, wherein the system attributes are preexisting attributes of the file data source, and wherein the custom attributes are defined by a user of the metadata source.

4. The system of claim 1, wherein the metadata query is created using a query generator that is preconfigured to optimize a table join of the metadata query based on source table cardinality of at least one of a plurality of metadata tables in the metadata source.

5. The system of claim 1, wherein the processor receives the REST request through a hypertext transfer protocol (HTTP) service interface.

6. The system of claim 1, wherein the metadata source stores metadata for a distributed file system that provides a global file namespace.

7. The system of claim 4, wherein the metadata query includes a UNION ALL to obtain a directory path name search in a first SELECT statement and a directory content search in a second SELECT statement.

8. A method for providing file metadata queries for a file system using representational stare transfer compliant (RESTful) application programming interfaces, the method comprising:
receiving a representational state transfer (REST) request that comprises a plurality of requested attributes and a plurality of search parameters;
identifying a metadata source comprising a plurality of source attributes that corresponds to the plurality of requested attributes;
using a translation configuration of the metadata source to convert the plurality of search parameters to obtain a plurality of converted parameters that is compatible with the metadata source;
creating a metadata query for the metadata source that comprises the plurality of requested attributes and the plurality of converted parameters; and
executing the metadata query to obtain metadata that includes the plurality of source attributes from the metadata source, wherein the plurality of source attributes are associated with a plurality of files stored in a file data source that is associated with the metadata source.

9. The method of claim 8, wherein the plurality of source attributes comprises system attributes and custom attributes, wherein system attributes are preexisting attributes of the file data source, and wherein custom attributes are defined by a user of the metadata source.

10. The method of claim 8, wherein the metadata query is created using a query generator that is preconfigured to optimize a table join of the metadata query based on source table cardinality of at least one of a plurality of metadata tables in the metadata source.

11. The method of claim 8, wherein the REST request is received through a hypertext transfer protocol (HTTP) service interface.

12. The method of claim 8, wherein the metadata source stores metadata for a distributed file system that provides a global file namespace.

13. The method of claim 10, wherein the metadata query includes a UNION ALL to obtain a directory path name search in a first SELECT statement and a directory content search in a second SELECT statement.

14. A non-transitory machine-readable storage medium encoded with instructions executable by a processor for providing file metadata queries for a file system using representational state transfer compliant (RESTful) application programming interfaces, the machine-readable storage medium comprising instructions to:
receive a representational state transfer (REST) request that comprises a plurality of requested attributes and a plurality of search parameters;
identify a metadata source comprising a plurality of source attributes that corresponds to the plurality of requested attributes;
use a translation configuration of the metadata source to convert the plurality of search parameters to obtain a plurality of converted parameters that is compatible with the metadata source;
create a metadata query for the metadata source that comprises the plurality of requested attributes and the plurality of converted parameters; and
execute the metadata query to obtain metadata that includes the plurality of requested attributes from the metadata source, wherein the plurality of requested attributes are associated with a plurality of files stored in a file data source that is associated with the metadata source.

15. The non-transitory machine-readable storage medium of claim 14, wherein the plurality of source attributes comprises system attributes and custom attributes, wherein system attributes are preexisting attributes of the file data source, and wherein custom attributes are defined by a user of the metadata source.
